(19) United States
(12) Patent Application Publication
(10) Pub. No.: US 2013/0249835 A1
(43) Pub. Date: Sep. 26, 2013

(54) USER INTERFACE SYSTEM AND METHOD

(71) Applicant: COMPUTER CLIENT SERVICES LIMITED, Camberley (GB)

(72) Inventor: Ian Muriss, Camberley (GB)

(73) Assignee: COMPUTER CLIENT SERVICES LIMITED, Camberley (GB)

(21) Appl. No.: 13/829,113

(22) Filed: Mar. 14, 2013

(30) Foreign Application Priority Data
Mar. 26, 2012 (GB) GB 1205267.6

(51) Int. Cl. G06F 3/0488

(52) U.S. Cl. CPC G06F 3/0488
USPC 345/173

(57) ABSTRACT

A computer implemented user interface system, method and computer storage medium is disclosed. A first user input is received via a user input device referencing a location in a locality (50) displayed in a user interface, the locality being at least a sub-area of an environment. Responsive to receipt of the first user input, the locality (50), and at least a part of one or more adjacent localities (50a) from the environment, are caused to be temporarily displayed in the user interface at a reduced scale.

### FIELD OF THE INVENTION

The present invention relates to a user interface system and method that is particularly suitable for providing context based navigation and context information for a computer system user interface.

### BACKGROUND TO THE INVENTION

Services such as web based online maps and satellite navigation for dedicated devices and for smart phones have dramatically increased use of computer generated maps. However, the usefulness of such maps has its limits.

Many ways of displaying maps and location information have been suggested, some more successful and intuitive than others. With the advent of low cost Global Positioning System (GPS) receivers, and also the significant increase in mobile devices that can access the internet, obtaining mapping information and obtaining mapping information relevant to an area is possible for many users.

However, there remains the problem that the maps themselves and the data provided has, in many aspects, not improved since the days of the paper based A-Z street maps with a location being searchable by name, locality or zip-code and the user then having to visually search and/or move the map to find the desired location. While advances such as Google's Street View® enables a map to be overlaid with information on the locality (in particular images of the locality), this service is very data intensive (meaning that mobile devices cannot always use this facility and even if it can, a user may not be patient enough to wait for the mobile device to retrieve the street view images). The service is also limited to areas where photographic imagery has been captured and the data overhead generally scales with the level of zoom of the map. Thus, the greater the area of the locality being displayed, the greater the amount of data needed to be downloaded.

Putting a map into context is a particular problem, particularly in a manner that can be intuitively displayed to a user whilst attempting to maintain a low data overhead for the context information.

It will also be appreciated that maps and navigation are not the only fields where context is desirable. For example, context within a document or when editing an image in a graphics package is important but not always immediately apparent to the user.

### STATEMENT OF INVENTION

According to an aspect of the present invention, there is provided a computer implemented user interface system comprising:
a processor configured to execute computer program code for executing a user interface system, including:
computer program code configured to receive a first user input referencing a location in a locality displayed in a user interface, the locality being at least a sub-area of an environment; and,
computer program code configured, responsive to receipt of the first user input, to cause the locality, and at least a part of one or more adjacent localities from the environment, to be temporarily displayed in the user interface at a reduced scale.

Preferably, the computer implemented user interface system further comprises:
computer program code configured to receive, while the locality is temporarily displayed in the user interface at a reduced scale, a second user input referencing a direction;
computer program code configured, responsive to receipt of the second user input, to cause panning, with respect to the environment and in the referenced direction, of the locality displayed.

The processor may be configured to execute computer program code for interacting with a touch display that is displaying the user interface, including:
computer program code configured to receive the first user input via the touch display; and,
computer program code configured to receive the second user input via the touch display.

The first and second user inputs may comprise different discrete gestures made as part of a continuous touch input via the touch display.

The first user input may comprise a long press gesture and the second user input comprises a drag gesture.

The processor may be further configured to execute in a loop computer program code including:
the computer program code configured to receive the first user input referencing the location in a locality displayed in the user interface; and,
the computer program code configured, responsive to receipt of the first user input, to cause the locality, and at least a part of one or more adjacent localities from the environment, to be temporarily displayed in the user interface at a reduced scale,
wherein in each execution of the loop the locality, and at least a part of one or more adjacent localities from the environment, are caused to be temporarily displayed in the user interface at a greater reduced scale.

The processor may be further configured to execute in a loop computer program code including:
the computer program code configured to receive the first user input referencing the location in a locality displayed in the user interface; and,
the computer program code configured, responsive to receipt of the first user input, to cause the locality, and at least a part of one or more adjacent localities from the environment, to be temporarily displayed in the user interface at a reduced scale,
wherein in each execution of the loop the locality, and at least a part of one or more adjacent localities from the environment, are caused to be temporarily displayed in the user interface at a greater reduced scale, and,
the processor being further configured to execute computer program code to break execution of the loop upon receipt of the second user input.

The processor may be further configured to execute computer program code including:
computer program code configured to record, in a memory, an initial scale at which the locality is displayed prior to being temporarily displayed in the user interface at the reduced scale; and,
computer program code configured, responsive to ending of the first user input, to read the initial scale from the memory and cause the locality to be displayed in the user interface at the initial scale.

The processor may be further configured to execute computer program code including:
computer program code configured to record, in a memory, an initial scale at which the locality is displayed prior to being temporarily displayed in the user interface at the reduced scale; and,
computer program code configured, responsive to ending of the continuous touch input via the touch display, to read the initial scale from the memory and cause the panned locality to be displayed in the user interface at the initial scale.

According to another aspect of the present invention, there is provided a computer implemented user interface method comprising:
a) receiving a first user input via a user input device referencing a location in a locality displayed in a user interface, the locality being at least a sub-area of an environment; and,
b) responsive to receipt of the first user input, causing the locality, and at least a part of one or more adjacent localities from the environment, to be temporarily displayed in the user interface at a reduced scale.

The method may further comprise:
c) receiving, while the locality is temporarily displayed in the user interface at a reduced scale, a second user input referencing a direction; and,
d) responsive to receipt of the second user input via the user input device, causing panning, with respect to the environment and in the referenced direction, of the locality displayed.

The user input device is preferably a touch display displaying the user interface, the method including:
receiving the first and second user inputs via the touch display.

The first and second user inputs comprise different discrete gestures made as part of a continuous touch input via the touch display.

The first user input may comprise a long press gesture and the second user input may comprise a drag gesture.

The method may further comprise performing steps a and b in a loop,
wherein in each performance of the loop, the locality, and at least a part of one or more adjacent localities from the environment, are temporarily displayed in the user interface at a greater reduced scale.

The method may further comprise performing steps a and b in a loop,
wherein in each performance of the loop, the locality, and at least a part of one or more adjacent localities from the environment, are temporarily displayed in the user interface at a greater reduced scale,
the method further comprising breaking execution of the loop upon receipt of the second user input in step c.

The method may further comprise:
recording, in a memory, an initial scale at which the locality is displayed prior to being temporarily displayed in the user interface at the reduced scale; and,
responsive to ending of the first user input, reading the initial scale from the memory and causing the locality to be displayed in the user interface at the initial scale.

The method may further comprise:
recording, in a memory, an initial scale at which the locality is displayed prior to being temporarily displayed in the user interface at the reduced scale; and,
responsive to ending of the continuous touch input via the touch display, reading the initial scale from the memory and causing the panned locality to be displayed in the user interface at the initial scale.

According to another aspect of the present invention, there is provided a non-transitory computer-readable storage medium containing instructions to provide a user interface system, the instructions when executed by a processor causing the processor to:
receive a first user input via a user input device referencing a location in a locality displayed in a user interface, the locality being at least a sub-area of an environment; and,
responsive to receipt of the first user input, cause the locality, and at least a part of one or more adjacent localities from the environment, to be temporarily displayed in the user interface at a reduced scale.

The non-transitory computer-readable storage medium may further comprise instructions when executed by a processor cause the processor to:
receive, while the locality is temporarily displayed in the user interface at a reduced scale, a second user input referencing a direction; and,
responsive to receipt of the second user input via the user input device, cause panning, with respect to the environment and in the referenced direction, of the locality displayed.

The term “context” is generally used herein to refer to data or information that is relevant to the locality that is being displayed. One of the most basic examples of context information is that of a current location identifier on a map. Such an identifier puts the information into context and removes the guesswork and/or assumption of knowledge of the locality required in the case where a map alone is displayed. Note that there are many ways in which context information could be displayed (or conveyed). In the example of “current location” context information, this can be displayed as a place-marker, it could be portrayed by centring of the map on the current location etc. It is also important to note that the locality need not be a physical locality. For example, it may be in relation to locality in a document, image or the like as discussed in detail below.

In one aspect, a data display system is arranged to cause context information to be displayed with data on a locality when output on a display, wherein:

the system is arranged to select one or more data points from a dataset, the dataset comprising context information linked to the locality, the system being arranged to select said data points from said dataset in dependence on said context information and cause displaying of an identifier on the display for context information of the or each selected data point, wherein the identifier is displayed on the display in a position determined in dependence on the locality and its link to the context information.

The link between the context information and the locality may be a distance measure (either geographical distance or some other distance such as a measure of difference in colour space). Context information could be one or plural attributes each on one of many different information types. For example geographical context information may be population, economic data on an area, pollution data, traffic flow/density. It will be appreciated that many other types of context data may be displayed either in isolation or in combination.

A weighting factor may weight selection in dependence on two or more attributes. For example, it may weight link magnitude (distance from displayed locality) against relative score of the context information with respect to other selected data points.

The location may be determined so as to place the identifier substantially adjacent the surroundings or adjacent an edge of the map leading to the respective surroundings.

Embodiments of the present invention may provide systems and methods for calculating and displaying (or providing for display) context related map information. Selected embodiments are directed to systems and methods for displaying maps in a User Interface which are enhanced using, in part, context information.

In one embodiment, mapping information may be displayed by a device capable of operating a GPS application wherein the position of the map reflects the approximate physical location of the electronic device. In another embodiment, a server may provide a map to a web browser in which a user may interact with the map by scrolling or otherwise repositioning a cursor on the map.

There are a number of reasons why it is desirable to add context information to mapping information, some of which are listed, by way of example only, below.

### 1) To Give Context to a Map.

If a user is looking at a map of an area then it is often useful to see where that area is relative to other locations. For example, showing signs to the nearest and/or largest towns is a much easier way for the user to get some idea of context than manually zooming out and zooming back in again. It should also be possible to turn signs on and off as required, so as not to obscure too much of the map on small screens.

In a preferred embodiment, the context of a map is to show a second map that is zoomed out from the first map, with the area shown on the first map highlighted by a rectangle on the zoomed out map. This second map is particularly suitable for the display of signs where they would add an extra level of context without getting in the way of the area of real interest on the first map.

### 2) To Provide a Means to Quickly Pan to a Location.

Interacting with an interface such as touching a sign can be made to pan the map (and possibly zoom in or out) to show that location. This provides a very effective mechanism for navigating a map. It can also be enhanced with browser-like “back” and “forward” buttons to enable users to quickly go back to areas that they have previously displayed.

3) To Provide Information about a Location of Interest that is not in the Current Visible Area.

Another possibility upon touching a sign is to show details about the location to which it points. This could also include the ability to edit either the location details or the characteristics of the sign displayed to point to that location (for example its text, size, colour and icon; under what conditions it is displayed etc).

### 4) To Aid Navigation to a Particular Point.

If used in conjunction with GPS and compass sensors then the signs can point in the real-world direction of a location. This is useful for when navigating to any location, such as a contact, or where the user left their car etc. It does not provide full routing information, but often the direction and distance is sufficient, even in the absence of an underlying map (for example where no network connection is available or data connectivity has been disabled).

5) To Show What You can See when at a Viewpoint

Another use in conjunction with GPS and compass sensors in the real world is to show what a user may be able to see when out and about. For example when a user is at a scenic viewpoint then the display of such signs can show them in which direction various points of interest are, such as towns, mountains etc. This helps them to identify what they are looking at in the same way as the horizontal plaques that are often on display at viewpoints.

As will be appreciated from the above, preferred embodiments of the present invention provide a touch based user interface. The functionality of signs or other visual representation of context information is increased if they are made touch sensitive, so that the user can perform certain operations by touching the sign. Different operations could be invoked by different types of touch: for example a single tap for one operation, a double tap for another, a long press for something else etc.

Embodiments of the present invention are directed to a system and method in which a potentially large data set of locations are parsed and selected ones are determined that should be displayed to the user in the form of signs or other information in a user interface (such as a screen) of a device. Such signs are usually overlaid on a map but not necessarily so.

Each sign preferably shows the name of the location and is oriented such as to point in the direction of that location. The sign will usually show the distance to the point in configurable units (for example miles or kilometres) and may also have some sort of icon associated with it.

The signs can work in conjunction with the display of points on the screen (such as when the location is within the bounds of the area shown). When the location goes from being within the area shown on the screen to outside that area, then a point shown on the screen may be replaced by a sign to that location. In some situations it may be that points are unnecessary but signs are still useful. For example when showing signs to towns or cities then displaying the town name on top of a map that already shows the name is unnecessary.

### BRIEF DESCRIPTION OF THE DRAWINGS

Embodiments of the present invention will now be described, by way of example only, with reference to the accompanying drawings in which:

FIG. 1a is a schematic diagram of a system according to an embodiment of the present invention;

FIGS. 1b-1e are illustrations of selected aspects of the system of FIG. 1a in use;

FIGS. 2a-2b are illustrations of selected aspects of the system of FIG. 1a in use in another embodiment;

FIG. 3 is a flow chart of a method of a navigation method according to an embodiment of the present invention;

FIG. 4 is a schematic diagram of system according to another embodiment; and,

FIGS. 5a-5c are screen shots illustrating the system of FIG. 4 in use.

### DETAILED DESCRIPTION

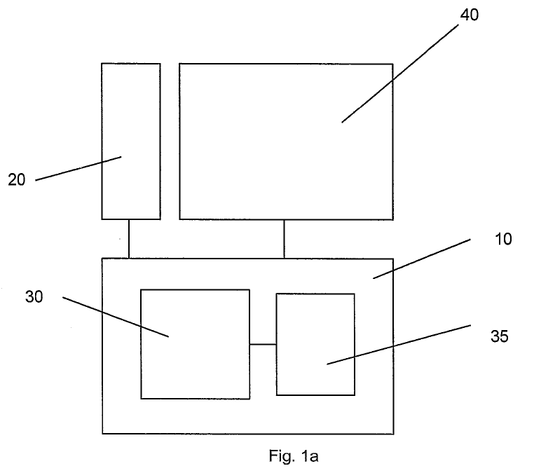

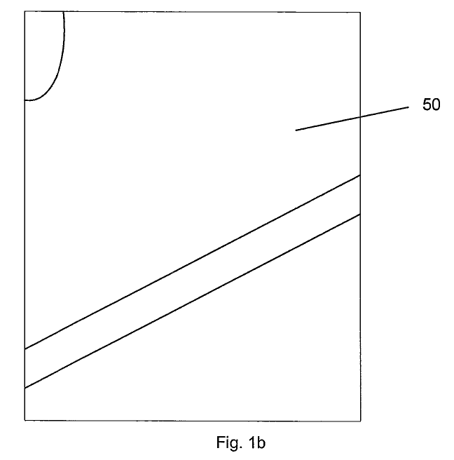

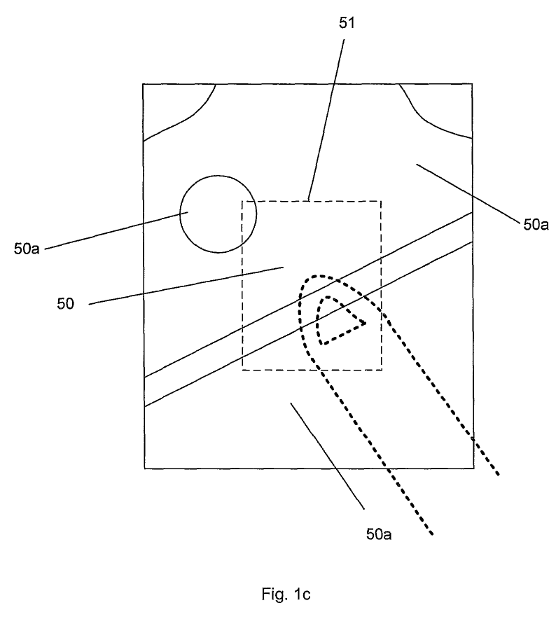

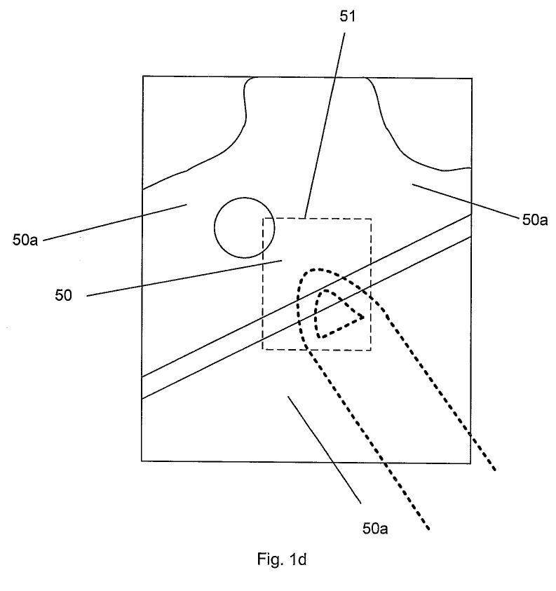

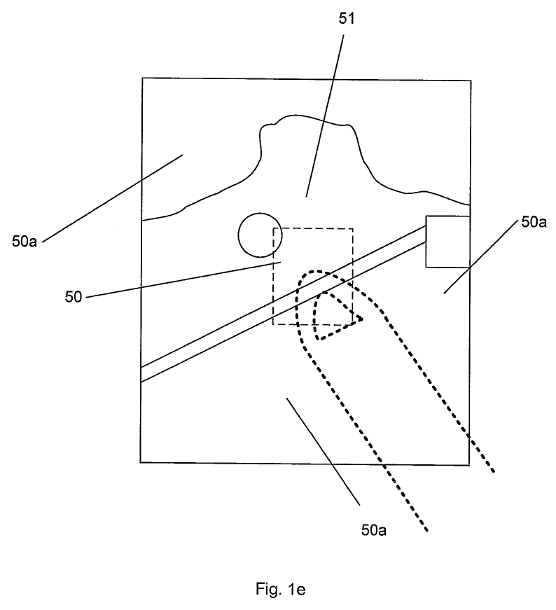

FIG. 1a is a schematic diagram of a system according to an embodiment of the present invention. The illustrated embodiment is in the form of an application running on a smart phone, although it will be appreciated that the general principles can also be applied to other devices/platforms such as web browsers, satellite navigation devices and the like.

A particularly useful way of showing context is to use what is referred to as “context zooming and panning”. The system 10 of FIG. 1a implementing the context zooming system includes a processor 30 and a memory 35 encoding computer program code executable by the processor 30. The processor is arranged, under control of the computer program code, to communicate with a user interface device 20 and a display 40 (which in some embodiments may be provided by the same device such as a touch sensitive display). The display is arranged to display at least a sub-area (referred to as a locality) of an environment 40′. In preferred embodiments, the environment 40′ extends beyond the display when displayed at a working zoom level such as a zoom level that a user may use to interact with the environment.

The system 10 could be invoked by the user interface device 20 in a number of ways. For example, invocation may be by a first user input (illustrated before user interaction in FIG. 1b) such as the user pressing and holding their finger on a touch sensitive screen or touchpad, as shown in FIG. 1c. Whilst their finger is down and stationary, as shown in FIG. 1c, the displayed locality 50 is zoomed out, whilst showing a rectangle 51 that outlines the initially displayed locality. The longer the user keeps their finger down then the further the displayed locality 50 is zoomed out (possibly up to a given limit), exposing adjacent localities 50a in the display 40, also at the same zoom level as shown in FIGS. 1d and 1e. This zooming out may be continuous whilst the finger is held down, or in discrete jumps at periodic intervals.

If the user then releases their finger then the display zooms back to the same locality 50 and at the zoom level they were initially at, but the user will have been given an indication of the adjacent localities 50a that are around the displayed locality 50.

Example environments include computer based maps, navigation displays, documents and graphical or photographical editing environments. For example, a user editing a photograph at a high zoom level may use the functionality to quickly zoom out, view the image at a reduced zoom level to obtain a view of the pixels being worked upon in context before releasing the touch and snapping back to the area being worked upon.

This “Context Zoom” works well in combination with the map signs described below in that both provide an indication of context, but with different strengths. Signs provide a constant but not comprehensive indication of context, whilst context zooming provides a more comprehensive indication of context on demand. Together the two approaches provide a way of minimising the problem of a smaller screen only being able to show a smaller area or lower detail than a larger screen.

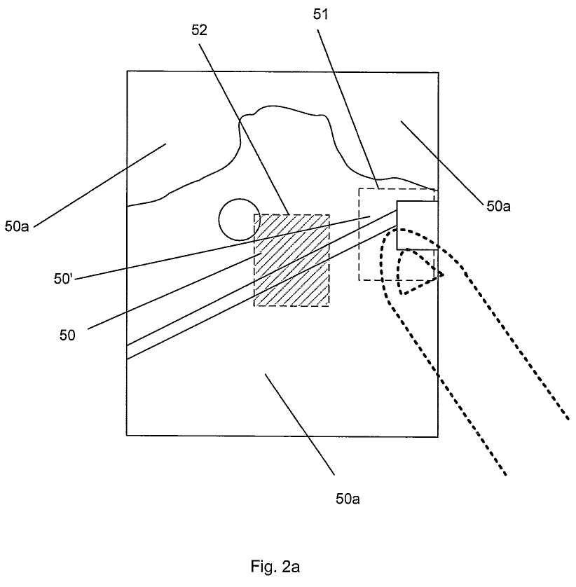

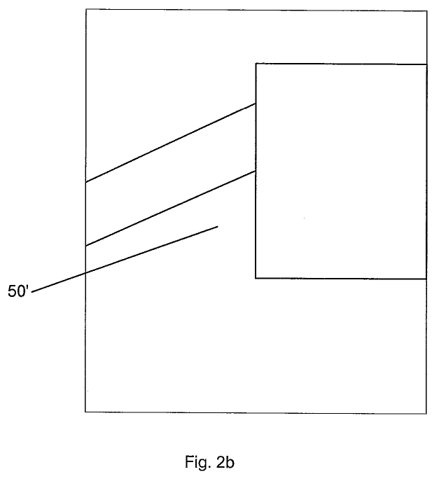

In addition to context zooming the approach can be extended to enable context panning as illustrated in the embodiment of FIGS. 2a-2b. In this embodiment, a second user input is detected while the display 40 is zoomed out under the action of the first user input. In FIG. 2a, the second user input includes the user moving their finger along the screen (whilst still applying the first user input by touching the screen). This second user input causes the rectangle 51 to move corresponding to the movement direction and speed of the second user input: Movement of the rectangle in effect pans the locality to move it in the environment to a new position 50′. If the user's finger reaches the edge of the display area or screen then the display area may move in that direction to allow the user to pan to areas off the screen. The original locality may optionally be marked on screen as a point of reference (or a way for the user to go back to where they started). In this embodiment it is shown as hatched area 52 but could be portrayed in many ways.

When the first user input is stopped by the user taking their finger off the screen, the display zooms (preferably smoothly and quickly) back to the original scale as shown in FIG. 2b, but showing the locality at which the rectangle is centred. As a result, navigation can in one embodiment be quickly and easily be achieved, a press causing zooming out, panning/translation in the environment at a zoomed out level by movement while still pressing the screen and then dropping back to the original zoom level but centred at the new locality all within a single touch based action. A particular advantage of this embodiment is that an environment can be worked on or interacted with during normal use at a high level of zoom/detail (so a detailed map or pixels of an image can be displayed) but the high zoom level can be temporarily be disabled during navigation to enable adjacent localities to be displayed and the user given an idea of context before being re-enabled at the working zoom level again once navigation is completed. Particularly in the case of maps and image editing, being able to drop back to the exact same zoom level is advantageous as it means that there is no risk that scale may be confused and that any editing operations can be continued with the re-assurance that they will have a consistent effect in the new locality to those in the previously displayed locality.

It will be appreciated that other touch or non-touch based invocation and control actions may be used.

This is a particularly powerful way to move around maps, and is much easier than the tradition approach of manually zooming out, panning across and then zooming back in again, which requires multiple fingers and multiple taps of the screen. Context Panning requires just one finger and one tap of the screen.

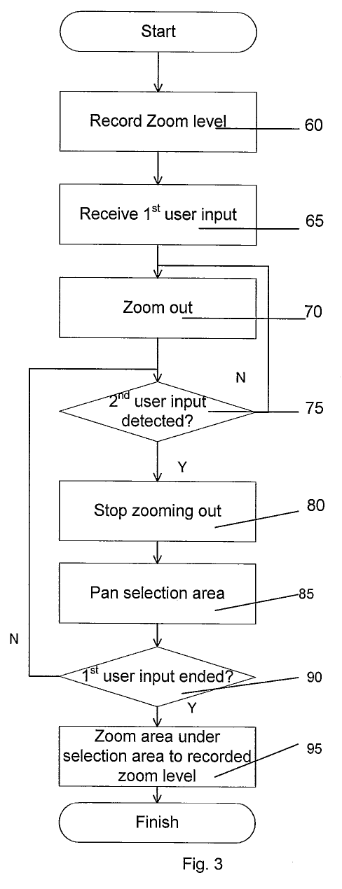

FIG. 3 is a flow chart of a method of a navigation method according to an embodiment of the present invention;

In step 60, the current zoom level is recorded in a memory. In step 65, a first user input is received referencing a location in a locality displayed in the user interface, the locality being at least a sub-area of an environment. In step 70, responsive to receipt of the first user input, the locality and at least a part of one or more adjacent localities from the environment, are caused to be temporarily displayed in the user interface at a reduced scale. A loop is executed in step 75 such that each first user input (or each of a predetermined time period over which the user input is applied) causes zooming. In step 80, the loop of step 75 is broken by a second user input referencing a direction being received and zooming is stopped. In step 85, responsive to the second user input, panning is caused with respect to the environment and in the referenced direction, of the locality displayed. In step 90, the application of the first user input is detected as being ended and in step 95 the zoom level is retrieved from memory and the locality currently displayed is zoomed to the zoom level.

As with signs described below, which also allow a quick way to move large distances in one discrete movement, context panning also benefits from being used in conjunction with back and forward buttons to allow users to retrace their steps if they wish.

It will be appreciated that context zooming and panning is a generic user interface feature that applies to more than just maps—it will work for any document larger than the screen.

In some ways it is the corollary of the “magnifying glass” that modern touch interfaces use to enable users to position things carefully on a small screen such as the iPhone® and iPad®. That system works by holding your finger down until a zoomed in view appears, moving your finger to position the cursor, and then lifting the finger to go back to the initial view. “Context panning” works in the same way but zooms out for large documents rather than zooming in for small ones.

The initiating gesture need not necessarily be a long touch but could be any other gesture, for example a double tap if the long touch gesture conflicts with existing gestures.

One possible implementation is as follows. When the system detects an initiating gesture, such as a long touch on the screen, it stores the point that is touched in terms of where it is on the screen (the pixel touched) and where it is on the map (the coordinates). It also stores the zoom factor and size of the map area in both pixel and map coordinates.

It then zooms out to a new zoom factor (either continuously, in discrete jumps or, for proximity sensing devices, in response to the distance of the finger from the screen) such that the pixel under the finger still shows the same map coordinates. One approach for the 2D embodiment where the system requires a centre and a scale factor would be to use the following equation:

Centre.X=Map.X+(0.5−Pixel.X/PixelSize.Width)*MapSize.Width*(Z+1);

Centre.X=Map.Y+(0.5−Pixel.Y/PixelSize.Height)*MapSize.Height*(Z+1);

Scale=InitialScale*Z;

### Where:

### Z=Zoom Factor

Pixel=touched pixel coordinates
Map=map coordinates of touched pixel
PixelSize=size of map in terms of pixels.
MapSize=size of the initial map area in terms of map coordinates

A rectangle or other boundary or delineation is shown around the area of the map that filled the screen when the user first initiated the operation.

When the user starts moving their finger then the system moves the rectangle to stay centred around the location of the user's finger. Whilst the touch position is near the edge of the map shown then the map area shown is periodically moved such that the area in the rectangle is what was previously off the screen. This could be implemented by initiating a timer that fires periodically and checks if the touched area is at the edge and then moves the map if it is. If the touch position is in a corner then the map is moved diagonally, otherwise it is moved horizontally or vertically accordingly.

When the user lifts their finger then the map is zoomed back such that the centre of the screen shows the map coordinates at the centre of the rectangle and the scale returns to the initial value.

In one embodiment, the original locality is shown or referenced in the user interface to enable to user to return to it should they decide not to pan away. For example, it may be portrayed as a rectangle in a different colour to the rectangle beneath the user's finger.

In one embodiment, zooming takes place in steps (or continuously) while the first input is applied but is ceased as soon as the second input is detected.

In an alternate embodiment, should the user interface device include or be able to access a proximity detecting device, which allows gestures where the device can detect the distance of the finger from the screen (often known as 3D gestures), then the zoom level could be controlled by the distance of the finger from the device/screen rather than by the time that the finger is initially held down. The further away from the screen that the finger is then the further the map will zoom out.

From the user's perspective this could be thought of as if the finger is attached to the map, either directly or by a piece of string between the user's finger and the position on the map screen below the finger. As the user moves their finger away from the device then it is analogous to them pulling the point of the map below their finger away from the screen and therefore pulling areas that were off the edges of the map into the map area, effectively zooming out. As a result one display option is to show the map as if this is the case. This would be particularly effective with future holographic displays.

The proximity based operation could be terminated by moving the finger closer to the screen (or actually touching it) on the area that the user wishes to pan to.

There are several advantages to this 3D approach. Firstly it is more intuitive to the user. Secondly the user can vary the zoom level during the pan stage of the operation. And thirdly the optional rectangle that shows the initial map area can be smaller without being obscured by the finger. The further the finger is from the screen then the smaller the rectangle but more of it can be seen because less is obscured by the user's finger.

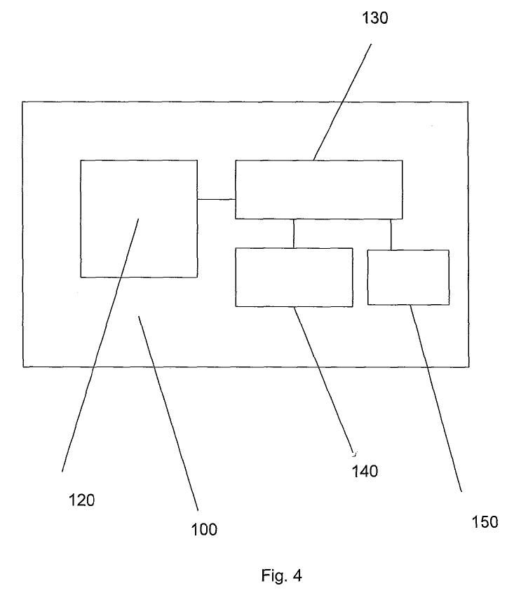

FIG. 4 is a schematic diagram of navigation system according to another embodiment.

The system 100 includes a user interface 120, a processor 130, a mapping data repository 140 and a context information data repository 150.

The processor 130 is arranged to access the mapping data repository 140 and context information data repository 150 and obtain data from each. The data from the context information data repository is processed as discussed below to generate a number of context identifiers. The processor 130 is arranged to overlay the context identifiers on a rendering of the mapping data and output the overlaid map to the user interface 120.

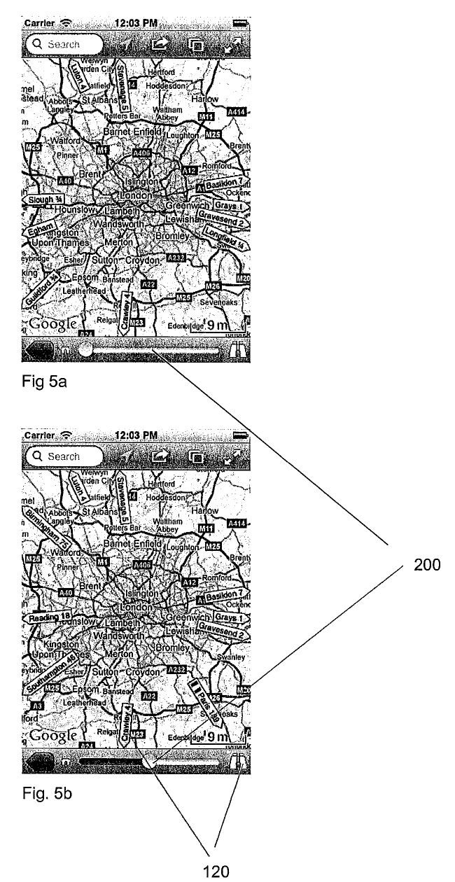

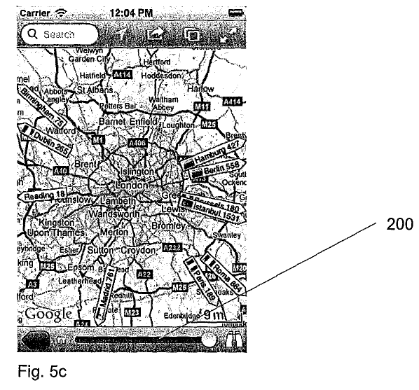

An example embodiment is shown in FIGS. 5a-5c. The examples use a data set of towns to illustrate context information. However, it will be appreciated that embodiments of the present invention may be used with any data set of locations and is particularly useful where the locations have some sort of weighting (for example the population of the town).

In the example discussed below, context information of towns weighted by population is used. However, the principles described could be applied to many types of location data, including general points of interest and points of interest to a specific user, for example their photos (so for example, an image database could be mapped using captured EXIF location/geo-tagging data) or their contacts which have been clustered by location and therefore can be weighted by their cluster size.

For any points, a filter control area can be displayed allowing filtering of the data shown. For example when showing restaurants, the filter may allow different types of restaurants to be shown or hidden. In another alternative (which could be used in addition to a filter) weightings may be given to different types of restaurant, enabling the user to prioritise signs to more distant favourites over nearby less desirable types. For example someone who prefers Chinese restaurants to Indian restaurants may see a sign to a Chinese restaurant 2 miles away in preference to a nearer Indian restaurant.

For weighted points (for example town populations, mountain heights, favourite types) the user interface 120 includes a control such as the form of a slider 200 that allows a user to vary a parameter which in turn varies the context information displayed. In the illustrated example, the parameter varies which towns are identified in the context information with one end of the slider biasing results towards those geographically nearby and the other biasing results towards those with the largest populations. The example screenshots in FIGS. 5a-5c show how operation of the slider effects the displayed information based on a map of London.

When the slider 200 is at its minimum, next to the small binoculars, it shows the towns of Slough, Egham etc as shown in FIG. 5a. When it is in the middle (the default) then it shows the cities of Birmingham, Reading and even Paris, as shown in FIG. 5b. At the right end of the parameter scale, the slider 200 is at the big binoculars and the user can “see” the cities of Dublin, Hamburg, and even Istanbul (because of its particularly large population) as shown in FIG. 5c.

This distance/size factor is where the user can decide if they want to see large towns or nearby towns. Preferably, this is represented as a value between 0 and 1, where 0 means show the nearest towns and 1 means show the largest towns (as shown in the screenshots).

Similarly with the previous example of favourite restaurant types the slider can control how far away a more distant favourite could be to still be shown in preference to a nearer less favourite restaurant.

A ‘shuffle’ function can also be provided that enables the user to see a different set of signs. If the user does not see anything of interest then they invoke this function and a different set of signs is displayed. For example if there were several points in a similar location off the map then there may not be room to show signs to all of the points in that direction. The algorithm used will identify the first choice of signs to show but this ‘shuffle’ operation enables the user to see the second choice signs, and the third etc. One of many ways of providing this shuffle function is to invoke it when it is detected by accelerometers or the like in the device that the user shakes the device while the system is running in the foreground of the device's operating system. This is consistent with several other ‘shuffle’ operations in different fields.

The processor 130 is arranged to calculate the context identifiers (referred to here as signs) that should be displayed using the procedure described below. Where the system is a user client device such as a smart phone or satellite navigation system, this is preferably performed in the background to avoid slowing down the main thread and impacting on the user's experience. Indeed, in such a situation, the context identifiers may be determined and overlaid asynchronously to the main map rendering thread such that the context identifiers are added in a subsequent refresh to the user interface and are not initially displayed.

In the preferred embodiments described below, the dataset is stored as a hierarchical structure so as to optimise access and processing of data records. However, it will be appreciated that other indexing and storage structures could be used.

### Hierarchy

The hierarchical data structure may be divided into levels or sub-types and these may in turn be divided into segments as discussed below. If the client device is not powerful enough to deal with the size of the dataset, then the processing of the datapoints into such an hierarchical structure may be performed off-line by a more powerful computer. For example if the intended device is a mobile phone and the dataset is thousands or millions of towns, then the data should be “pre-processed” on a desktop PC, which transforms the data into a hierarchical structure that can be efficiently handled by the intended device.

In the embodiment above in which towns/cities are indexed, levels are determined by the “size” of the point, which in this embodiment is the population. The top level of the hierarchy contains the largest towns (for example a population of 1 million+), the next level contains largish towns (100,000+), then a level of smaller towns etc, with the bottom level being towns without population information. Each level is optionally divided into segments, the size of which is dictated by the system parameters such as the capabilities of the user/processing device and the number of towns at that level. The division could be done on a number of different criteria, although in this example it is done by splitting to ensure a roughly equal number of locations in each segment. With this approach, the geographical area covered by each segment could vary dramatically.

For example, in an embodiment in which processing was done on a smart phone such as the iPhone®, the top level may be defined to cover the whole world, because there are only 300 or so towns in the world with a population of over 1 million. The next level has several thousand towns. In order to avoid loading all that data in one go, the level is segmented by using some sort of space-partitioning data structure, such as a KD tree.

Datasets from a number of closest segments may be considered in the processing step discussed below. The number of segments considered may be determined by a sum of their respective datasets with regard to a threshold or it may simply be a predetermined system parameter.

It will be appreciated that sub-division may not be necessary for all datasets, particularly if compression techniques are used on the datasets such that the overhead in retrieving the datasets is reduced.

It will also be appreciated that the hierarchy need not be for storage of the datasets—it could define an index with each datapoint in the dataset being a link or pointer to the actual data that may be stored as a flat file or the like and that data may be stored on the processing device or remotely of the processing device.

Each segment (and optionally each sub-segment) may optionally be stored as a separate file or data item.

### Parsing

In order to determine the level of the hierarchy appropriate to the map being viewed, the system 10 processes the hierarchy starting with the largest weighted or favourite subtypes, and working down through levels until it reaches a point where the potential dataset is at the threshold of being manageable (or it is considering the full dataset of the hierarchy levels).

In terms of judging when handling the dataset would be unmanageable, this is achieved by working through the levels, determining which segments need to be processed until the number of areas reaches a certain level. The are preferably divided up to be equal in terms of the number of points they contain rather than geographic area, so the number of segments is proportional to the time taken to determine the signs.

As an example if you are looking at a map of Europe then there may be 1 segment at level 1 that overlaps it, ten segments at level 2 (say), thirty segments at level 3, a hundred segments at level 4 etc. If you know that the device is not particularly powerful then you may say that it can do 20 segments at most. This would mean going down to level 2 but not processing any from level 3 (or maybe processing the closest areas in level 3). If you have a more powerful device then you may process all of level 3. You may even want to offer the option to the user whereby they can trade of speed of execution against the number of cities examined.

If they were looking at London, then it may be one area at level 1 but then only three areas at level 2, because the viewed area is smaller, and then five areas at level 3 etc. So you can go down to smaller towns whilst still not exceeding your limit of the number of areas that can be processed. The algorithm works well because you are unlikely to want to see signs to small towns, like Woking for example, on a map of Europe, but you may want to see them on a map of London.

As another example, if a map of the whole England was being considered, the system would correlate the map with the hierarchy and, starting at the top most level move down through the hierarchy until it reached a level where checking all the towns that could be of interest would be too much work. In the case of a smart phone based application, it would likely not get down to the lowest level because there would be too many rectangles overlapping England for an iPhone to process. A desktop PC would probably be able to handle the lowest level, but probably wouldn't want to anyway—if you are looking at the whole of England then you are unlikely to want to see a sign to a small hamlet near Edinburgh. This may be achieved by having a system parameter linking datapoints to be processed to a zoom level of the map being viewed.

As an alternative approach, segment determination may be performed by selecting the lowest level (highest supportable level of detail) and then working upwards to populate the dataset. In such an arrangement, the initial context information zoom level is determined using the size of the area of the map being shown. For example, if we are looking at the whole of Europe then there is no point looking at the level containing towns with a population of 1,000. Preferably, this is a conservative check, so we may look at cities with a population of greater than 100,000 even if we suspect that we will be most interested in those greater than 1,000,000. The next step determines if this is the right level.

The system then determines the segments (such as rectangles files) at this starting level that overlap the current area being displayed. It may then add adjacent segments on all sides to its selection, so that a location in the next segment that could be just off the edge of the map is not missed. This will give a set of segments of interest. If the size of this set is greater than a predetermined value (a system parameter that is typically selected dependent upon the processing power of the device) then this “zoom” level is ignored and the system tries the next zoom level up in the hierarchy to use as the base level.

In the European example described above, the system would probably find that the 100,000 level results in too many rectangles and therefore moves up to the 1,000,000 level. This process only requires a few index files to be opened and is therefore very efficient.

Once the system has determined a base level in the hierarchy that produces an acceptable number of segments, it then carries on up the hierarchy, finding on each level those segments that are overlapping or adjacent to an overlapping segment, until we get to the top level. In this manner, the set may include have many files from one level, some from the level above and only a few from the top level.

Another way of separating weighted points into a hierarchy of levels is to use weights relative to geographically nearby points. In this approach the largest point or points in a given area goes into the first level, the next largest into the next level and so on. This is particularly useful where large weighted points are clustered, such as with mountains for example. If mountains were separated into levels purely by their elevations then the first level would be mostly from the Himalayas.

This can be avoided by separating the data into segments using some sort of space partitioning approach such as binary trees, and then putting the largest weighted points in each segment into the first level, the next largest into the next and so on. As before each level is then separately partitioned into segments.

Using this approach a map of England may consider showing signs to locally important mountains such as Snowdon or Ben Nevis as well as considering showing signs the largest mountains in the Alps or Nepal. The slider described before would assist deciding which signs to show.

Points may also be broken down into subtypes with a separate segmentation for each subtype. The system then iterates through the subtypes in order (possibly specified by the user as an indication of their favourites).

### Dataset Processing

Now that a set of segments (possibly of varying scales) has been determined, the system processes each of the segments/files. This can produce a dataset representing potentially many points to evaluate. This processing requires iteration through each datapoint (town) in each segment/file, applying a function to the town's position and population to produce a representative value for each town. For each town in the produced dataset, a value based on the weight (for example population of the town), its distance from the area shown, and the distance/size factor is calculated. This algorithm could involve determining two roots from the factor, one of which is applied to the size and one to the distance. The results are then combined to give a representative value for that town that is subsequently used in determining whether to display it as context information on the map.

This function needs to be as efficient as possible because it gets used frequently. Preferably, it is performed as a background process. Performing this process in a background thread means that even if the calculation is very slow, it does not affect the smoothness of the application. However the slower the calculation, the longer it will take for appropriate signs to replace out of date signs, which will still smoothly move around the screen as necessary but may not be the best signs to display.

The function applied to each town to calculate a relative value does the following:

Calculate the distance from the centre of the displayed area to the town, in units of the size of the rough “radius” of area shown.

SizeRoot=SizeRootFunction(Factor)

DistanceRoot=DistanceRootFunction(Factor)

Value=(Size to the power of SizeRoot)/(Distance to the power of DistanceRoot)

Note that there is no need to perform the square root component when calculating the Cartesian distance (d=sqrt(sq(x1−x2)+sq(y1−y2)) of the point from the map because this can be incorporated in the DistanceRoot and saves performing two expensive “power” calculations.

The functions used depend on the type and size of the dataset, and the power of the device. An example function that works well with a large dataset of towns on a current mobile device is SizeRoot=0.3+factor/2, and DistanceRoot=0.8−factor/2. Future mobile devices will undoubtedly be more powerful and may be able to handle more accurate functions in real-time. For example greater processing power could allow the use of functions that determine the spherical distance using latitudes and longitudes rather than the Cartesian distance using a flat Earth projection. As an aside, note that the distances shown on the relatively few displayed signs can still be calculated using a spherical Earth, even if the algorithm that determined which signs to display from a large dataset had to use a flat Earth calculation for efficiency.

For example, if the area is 1000 miles across and the town is 2000 miles away then it would be 4 “units”. For efficiency Mercator projection is used so that distances can be calculated using simple “flat earth” geometry thus: sqrt(xDiff*xDiff+yDiff*yDiff). This is not ideal but a lot quicker than using latitudes and longitudes and is fine for most scales. It only becomes an issue at large scales when the choice of cities becomes more affected by population than distance and so the distance errors due to the projection are less of an issue.

This value is determined to be sufficient where points have no conceptual size, but if they do (for example the population of towns) then the function then calculates the n^{th} root of this distance where n is dependent upon the distance/population factor provided. It also calculates a root of the population, again using a value of n dependent upon the population factor (although with an inverse relationship). The value returned by the function is the root of the population size over the root of the distance.

The exact values used for these roots are application and data specific, and may depend on how the data is compressed.

The root of the population size can be cached until the user changes the distance/population factor. This means that in most cases the function is only performing one root calculation (on the distance).

The same function is being performed on many values, which makes it ideal for optimisation using a part of the CPU called a “vector processor”, which is present on a lot of devices and can rapidly speed up such calculations. This may necessitate a restructuring of the point data, which is more efficiently performed during the pre-processing. Vector processors usually rely on data of the same type being consecutively located, so it may help to separate the location details (and size if present) from the rest of the point data (name, country etc).

It may be more efficient to have vector files, each containing a list of eastings, a list of northings and (optionally) a list of sizes. There is no need to load in the names of points until after the locations and sizes have been processed and the points filtered. The corresponding names and other details can then be loaded from the other files later on (possibly using the position of the points within the vector files as an index for the details files).

The calculated values are then sorted and the datapoints corresponding to the top N values are used to cause context related information (such as signs) to be displayed on the map.

For the top ‘N’ values, N may be selected to be greater than the required number of signs for example to take into account that:
1) We may wish to hide any signs that will be partially or completely obscured by a more important sign.
2) We may wish to spread the signs out, favouring signs that are further apart from each other (see later).
3) We may wish to keep a small set of possible signs and re-evaluate only this set frequently (for example on every movement), whilst only performing a complete re-evaluation less often (possibly every quarter or third of a complete screen movement).
4) We may wish to provide a ‘shuffle’ function allowing the user to cycle through different sets of signs.

This set of signs can be determined by simply calculating values for all the signs identified as likely candidates and then sorting this set using a known sorting algorithm that only separates the top ‘n’ out of ‘m’ values. So if you want the top 100 out of 10000 values then the sort would ensure that the first 100 values are those required (but not necessarily in order). It does not waste time sorting the rest, or even sorting those 100, which makes it much more efficient in this situation than traditional sorting algorithms.

If the dataset is large then it may be possible to optimise this further, depending on the efficiency of the sorting algorithm. One possible approach is to iterate through the values and periodically sort them in small batches rather than sorting the whole set at once. For example we could use a buffer that is larger than the number required (say two or three times as large). We could then add each value to the buffer, one by one, until the buffer is full. When it is full then the sort described above is applied to effectively reduce the number of items in the buffer to the number required.

At this time the algorithm can also determine the lowest value of the items left in the buffer. This value can then be used to filter future values in the set, so that only values greater than this minimum value are added to the buffer. With each successive sort the minimum filter value will get higher and the frequency of sorts should get lower.

In order to maximise the effect of this filter, the system is arranged to attempt to ensure that the most likely candidate points are added to the buffer first. This can be done in several ways. For example the files with the largest weights can be evaluated first. And then when looking at points of the same scale then the rectangles should be evaluated in an order determined by how far they are from the area of interest. If the largest and closest points are evaluated first then most of the other points will be filtered out and fewer sorts will be required.

As indicated above, although the calculation results in an ordered set of datapoints, it may be that some may overlap when translated into signs or the like.

In one embodiment, overlap may be considered at rendering time such that when a sign for a datapoint overlaps one already displayed, that datapoint (and its sign) is dropped. In such circumstance, the system may optionally drop that datapoint and select one having a lower ranked value. For example it may be that Edinburgh is the highest ranking value and Perth the second. However, Perth is in the same direction, so is rejected.

In another embodiment, visual spread of signs may be taken into account at rendering time so as to be more pleasing to the eye. For example it may be that the towns with the largest values are all at the top of the screen. In such a situation it may be nicer to show a few of these but also show at least a few of the towns in other directions, even if they are further away or smaller.

One approach to avoid (or minimise) overlapping signs is to apply a “spreading factor”. The town with the highest value in the surrounding locality is selected and a context identifier (for example a sign) is placed on the map to that town at a position determined in dependence on the relative position of the town to the map (typically at the edge leading towards the town). The system then looks through the rest of the towns and applies a weighting based on how far away (in bearing terms) a sign for each of the other towns would be from the first sign. It then re-sorts the weighted values and the town with the highest weighted value is plotted next. It then repeats the check, weighting the initial values using the distance from either of the first two signs, and repeats until the required number of signs are found. This means that the top values aren't necessarily used, which is one of the reasons why more than N values may be returned as discussed above.

In one embodiment, calculated values are weighted based on how far they are (in bearing terms) from signs that have already been displayed. For example, if the 5 towns with the highest values were to the north of the map but without overlapping signs, and the next 5 towns had almost as high values but were in other directions then a weighting factor may cause these to be rejected and lower ranked datapoints pointing elsewhere may be selected due to influence of the weighting.

After the first displayed sign, each ranked candidates value is considered in order and a “spreading factor” multiplied by the distance in radians from that first sign is applied. So for example if the second town has a value of say 20 and the third town has a value of 19 but, but a sign to the second town would be next to the first sign and the sign to the third town would be pointing in a completely different direction, then the sign for the third town is shown next. This is then repeated using the distance in radians from any or all of the signs chosen so far.

The use of a “spreading factor” means that this can be controlled such that it makes no difference (a factor of 0, where the towns with the highest values are used, subject to overlapping), or such that the signs are as evenly spaced as possible using the subset of towns produced by the dataset calculation discussed above. The spreading factor used is dependent upon the application. For browsing the world map, a low spreading factor may be used so it makes a slight difference where values are similar but doesn't generally interfere with what is shown. However for a viewpoint mode where the user often wants to know what is in each direction, a high spreading factor may be used. The factor could even be made available to be controlled by the user, although it would likely be an advanced option as it is not as easy to explain as the distance/size factor.

One side benefit of this is that we can remove overlapping towns quite easily by using a weighting of 0 if a sign is within a few degrees of an existing sign. The tolerance of this depends on the size of the screen, so a tablet may allow signs to be a couple of degrees away from each other, but a phone would be less tolerant.

### Changing Sign Angles

Another way to avoid overlapping signs is to move their position on the edge of the screen. By default all signs are displayed with the point of the sign touching the edge of the screen at the intersection between the edge and a line from the centre of the screen to the location. When two signs are close together on the edge and we want to show both signs then one or both of the signs can be moved and their angle adjusted so that they still point to the location.

This approach is particularly useful where we do not want to hide either of the overlapping signs. However the more a sign's angle is changed then the more it gets in the way of other signs, so this method should be used with caution. It can also be less aesthetically pleasing, although such things are subjective.

### Miscellaneous Enhancements

The algorithm may be enhanced to add extra functionality when displaying signs, such as not showing the icon if most of the displayed signs have the same icon (useful for showing country flags when towns are from several countries).

The user may wish to configure some signs to always or never be displayed, so the algorithm should also allow for such functionality, either by maintaining sets of such locations or possibly (for excluded locations only) by modifying the location data accordingly.

We may wish to hide or vary the size of signs if they would obscure data on the map that we do not wish to be obscured. For example if we are showing points of interest on a map and the signs are there simply to show points that are off the map then we may wish to prioritise the points on the map over the signs to points off the map. Therefore it may be that we do not wish to show signs if they would obscure points. Or we may wish to shrink the signs such that they do not obscure the points or obscure them as little as possible.

One approach to this is to maintain a grid where the contents of each cell represent an area of the screen. The values in each cell are set to describe to what extent that area of the screen contains elements that we do not wish to obscure with signs. Then for each sign we iterate through the cells in the grid that a sign would cover and determine how much, if any, of the sign can be displayed. The cell size of the grid in terms of pixels is a trade off between accuracy (small cells) and efficiency (larger cells) and depends on the processing power available. Smaller cells would allow finer granularity of determining where there is room for a sign, but would require more processing power to fill them in (a point would cover more cells) and also to check if a sign can be displayed (more cells would need to be checked).

### Pre-processing

If there is a lot of location data then it can be pre-processed for efficiency at run-time. Such pre-processing takes a list of locations and maybe other data (for example population and country code in the case of towns) and breaks the data down into smaller files which can be loaded and examined as required.

For town signs we start with a file containing the location, population and ISO country code of about 100,000 towns and cities around in the world with a population greater than 1,000 people. We then break this list down into a set of “rectangles”, each with a roughly equal number of towns. Note that this means that some rectangles are much larger than others in geographic terms—one may stretch across a lot of the empty Atlantic whilst another is only the size of London.

For each rectangle we then store a file of the towns that it contains, with each entry containing the name of the town, the country, population and location (in Mercator projection terms to speed up distance calculations).

This process is repeated several times, each for towns of different sizes. For example the first time could be for towns between 1,000 and 9999, then from 10,000 to 99,999, then from 100,000 to 999,999 and then for those with a population of over 1 million. So there are several levels, each containing many data and index files.

While several embodiments have been described other systems and devices may include functionality provided by embodiments of the present invention. Such devices may include personal digital assistants (PDAs), pagers, laptop computers, desktop computers, gaming devices, cameras, GPS devices, as well as other types of electronic systems including both mobile, wireless devices and fixed, wireline devices.

In the illustrated example, much of the system may be implemented as software and is executed on the processor. However, more generally, the system may be implemented as software, hardware, firmware, or any appropriate combination thereof.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer implemented user interface system comprising:
a processor configured to execute computer program code for executing a user interface system, including:
computer program code configured to receive a first user input referencing a location in a locality displayed in a user interface, the locality being at least a sub-area of an environment; and,
computer program code configured, responsive to receipt of the first user input, to cause the locality, and at least a part of one or more adjacent localities from the environment, to be temporarily displayed in the user interface at a reduced scale.

2. The computer implemented user interface system of claim 1, wherein the processor is further configured to execute computer program code including:
computer program code configured to receive, while the locality is temporarily displayed in the user interface at a reduced scale, a second user input referencing a direction; and,
computer program code configured, responsive to receipt of the second user input, to cause panning, with respect to the environment and in the referenced direction, of the locality displayed.

3. The computer implemented user interface system of claim 2, wherein the processor is configured to execute computer program code for interacting with a touch display that is displaying the user interface, including:
computer program code configured to receive the first user input via the touch display; and,
computer program code configured to receive the second user input via the touch display.

4. The computer implemented user interface system of claim 3, wherein the first and second user inputs comprise different discrete gestures made as part of a continuous touch input via the touch display.

5. The computer implemented user interface system of claim 4, wherein the first user input comprises a long press gesture and the second user input comprises a drag gesture.

6. The computer implemented user interface system of claim 1, wherein the processor is further configured to execute in a loop computer program code including:
the computer program code configured to receive the first user input referencing the location in a locality displayed in the user interface; and,
the computer program code configured, responsive to receipt of the first user input, to cause the locality, and at least a part of one or more adjacent localities from the environment, to be temporarily displayed in the user interface at a reduced scale,
wherein in each execution of the loop the locality, and at least a part of one or more adjacent localities from the environment, are caused to be temporarily displayed in the user interface at a greater reduced scale.

7. The computer implemented user interface system of claim 2, wherein the processor is further configured to execute in a loop computer program code including:
the computer program code configured to receive the first user input referencing the location in a locality displayed in the user interface; and,
the computer program code configured, responsive to receipt of the first user input, to cause the locality, and at least a part of one or more adjacent localities from the environment, to be temporarily displayed in the user interface at a reduced scale,
wherein in each execution of the loop the locality, and at least a part of one or more adjacent localities from the environment, are caused to be temporarily displayed in the user interface at a greater reduced scale, and,
the processor being further configured to execute computer program code to break execution of the loop upon receipt of the second user input.

8. The computer implemented user interface system of claim 1, wherein the processor is further configured to execute computer program code including:
computer program code configured to record, in a memory, an initial scale at which the locality is displayed prior to being temporarily displayed in the user interface at the reduced scale; and,
computer program code configured, responsive to ending of the first user input, to read the initial scale from the memory and cause the locality to be displayed in the user interface at the initial scale.

9. The computer implemented user interface system of claim 4, wherein the processor is further configured to execute computer program code including:
computer program code configured to record, in a memory, an initial scale at which the locality is displayed prior to being temporarily displayed in the user interface at the reduced scale; and,
computer program code configured, responsive to ending of the continuous touch input via the touch display, to read the initial scale from the memory and cause the panned locality to be displayed in the user interface at the initial scale.

10. A computer implemented user interface method comprising:
a) receiving a first user input via a user input device referencing a location in a locality displayed in a user interface, the locality being at least a sub-area of an environment; and,
b) responsive to receipt of the first user input, causing the locality, and at least a part of one or more adjacent localities from the environment, to be temporarily displayed in the user interface at a reduced scale.

11. The computer implemented user interface method of claim 10, further comprising:
c) receiving, while the locality is temporarily displayed in the user interface at a reduced scale, a second user input referencing a direction; and,
d) responsive to receipt of the second user input via the user input device, causing panning, with respect to the environment and in the referenced direction, of the locality displayed.

12. The computer implemented user interface method of claim 11, wherein the user input device is a touch display displaying the user interface, the method including:
receiving the first and second user inputs via the touch display.

13. The computer implemented navigation method of claim 12, wherein the first and second user inputs comprise different discrete gestures made as part of a continuous touch input via the touch display.

14. The computer implemented user interface method of claim 13, wherein the first user input comprises a long press gesture and the second user input comprises a drag gesture.

15. The computer implemented user interface method of claim 10, further comprising performing steps a and b in a loop,
wherein in each performance of the loop, the locality, and at least a part of one or more adjacent localities from the environment, are temporarily displayed in the user interface at a greater reduced scale.

16. The computer implemented user interface method of claim 10, further comprising performing steps a and b in a loop,
wherein in each performance of the loop, the locality, and at least a part of one or more adjacent localities from the environment, are temporarily displayed in the user interface at a greater reduced scale,
the method further comprising breaking execution of the loop upon receipt of the second user input in step c.

17. The computer implemented user interface method of claim 10, further comprising:
recording, in a memory, an initial scale at which the locality is displayed prior to being temporarily displayed in the user interface at the reduced scale; and,
responsive to ending of the first user input, reading the initial scale from the memory and causing the locality to be displayed in the user interface at the initial scale.

18. The computer implemented user interface method of claim 13, further comprising:
recording, in a memory, an Initial scale at which the locality is displayed prior to being temporarily displayed in the user interface at the reduced scale; and,
responsive to ending of the continuous touch input via the touch display, reading the initial scale from the memory and causing the panned locality to be displayed in the user interface at the initial scale.

19. A non-transitory computer-readable storage medium containing instructions to provide a user interface system, the instructions when executed by a processor causing the processor to:
receive a first user input via a user input device referencing a location in a locality displayed in a user interface, the locality being at least a sub-area of an environment; and,
responsive to receipt of the first user input, cause the locality, and at least a part of one or more adjacent localities from the environment, to be temporarily displayed in the user interface at a reduced scale.

20. The non-transitory computer-readable storage medium of claim 19, further comprising instructions when executed by a processor cause the processor to:
receive, while the locality is temporarily displayed in the user interface at a reduced scale, a second user input referencing a direction; and,
responsive to receipt of the second user input via the user input device, cause panning, with respect to the environment and in the referenced direction, of the locality displayed.
